(19) United States
(12) Patent Application Publication
(10) Pub. No.: US 2024/0138967 A1
(43) Pub. Date: May 2, 2024

(54) DENTAL SHADE MATCHING GUIDE

(71) Applicant: Jed Archibald, Lehi, UT (US)

(72) Inventor: Jed Archibald, Lehi, UT (US)

(21) Appl. No.: 18/384,830

(22) Filed: Oct. 27, 2023

Related U.S. Application Data
(60) Provisional application No. 63/420,016, filed on Oct. 27, 2022.

(51) Int. Cl. A61C 19/10

(52) U.S. Cl. CPC A61C 19/10

(57) ABSTRACT

A dental matching shade swatch comprising a shade tip, the shade tip comprising a transparent adapter central core, and an outer shade sample material surrounding the transparent adapter central core. The dental matching shade swatch also comprises a transparent fastener for rotatably connecting the shade tip to a post, the post insertable into a void of a housing, and a positioning notch extending above the transparent adapter central core, the positioning notch formed of a transparent material and the positioning notch facilitating positioning the outer shade sample material proximal to a patient's tooth.

### CROSS-REFERENCE TO RELATED APPLICATION

A claim for priority to the Oct. 27, 2022 filing date of U.S. Provisional Patent Application No. 63/420,016, titled DENTAL SHADE MATCHING GUIDE (“the '016 Provisional Application”), is hereby made pursuant to 35 U.S.C. § 119(e). The entire disclosure of the '016 Provisional Application is hereby incorporated herein.

### TECHNICAL FIELD

This disclosure relates generally to various embodiments of shade guide. More specifically, it relates to a shade guide to match shades of dental prosthesis to the shade of a dental patient's teeth. The features disclosed herein are numerous in nature and may be employed in various different ways to provide the same or similar results.

### BACKGROUND

Dental shade guides assist dentists in selecting an appropriate shade for dental prosthesis (e.g., artificial teeth, veneers, dental implants, etc.) in the context of dental restoration. Some shade guides comprise a number of artificial teeth of various different shades. A dentist may place false teeth from the shade guide near a dental patient's natural teeth to compare the false teeth with the patient's natural teeth in order to facilitate the selection of a shade that closely approximating the coloring of the patient's natural teeth.

### SUMMARY

This disclosure relates to various embodiments of a shade swatch that comprises a shade tip attached to an end of a post, the shade tip comprising a fastener securing an adapter to the end of the post, the adapter comprised of a transparent material, and a shade sample fixed to the adapter. The shade sample may be formed of a material that is at least partially opaque and has a curved shape that is tapered from a thick portion of the material to a relatively thin portion of the material. The adapter may comprise a positioning notch that extends upward above the shade sample.

This disclosure also relates to a dental matching shade swatch that comprises a shade tip in connection with a post. The shade tip may comprise a transparent adapter central core, and an outer shade sample material surrounding the transparent adapter central core; and a positioning notch extending above the transparent adapter central core, the positioning notch formed of a transparent material and the positioning notch facilitating positioning the outer shade sample material proximal to a patient's tooth.

The dental matching shade swatch of may further comprise a fastener for rotatably fastening the transparent adapter central core to a post.

The outer shade sample material may have a thickness around the transparent adapter central core, and the thickness may vary from a first side of the transparent adapter central core to a second side of the transparent adapter central core.

The outer shade sample material may have a thickness around the transparent adapter central core, and the thickness may be uniform.

This disclosure is also related to a dental matching shade swatch that comprises a shade tip. The shade tip may comprise a transparent adapter central core, and an outer shade sample material surrounding the transparent adapter central core. The shade tip may also comprise a transparent fastener for rotatably connecting the shade tip to a post, the post insertable into a void of a housing, and a positioning notch extending above the transparent adapter central core, the positioning notch formed of a transparent material and the positioning notch facilitating positioning the outer shade sample material proximal to a patient's tooth.

### BRIEF DESCRIPTION OF THE DRAWINGS

In the drawings:

FIG. 1 is a perspective view of an embodiment of shade guide;

FIG. 2 is a front view of the embodiment of the shade guide shown in FIG. 1;

FIG. 3 is a left side view of the embodiment of the shade guide shown in FIG. 1;

FIG. 4 is a back view of the shade guide shown in FIG. 1;

FIG. 5 is a right side view of the shade guide shown in FIG. 1;

FIG. 6 is a top view of the shade guide shown in FIG. 1; and

FIG. 7 is a bottom view of the shade guide shown in FIG. 1.

FIG. 8 is a perspective view of an embodiment of a shade swatch for use with a shade guide;

FIG. 9 is a front view of the embodiment of the shade swatch shown in FIG. 8;

FIG. 10 is a left side view of the embodiment of the shade swatch shown in FIG. 8;

FIG. 11 is a back view of the shade swatch shown in FIG. 8;

FIG. 12 is a right side view of the shade swatch shown in FIG. 8;

FIG. 13 is a top view of the shade swatch shown in FIG. 8; and

FIG. 14 is a bottom view of the shade swatch shown in FIG. 8.

### DETAILED DESCRIPTION

The following provides a detailed description of particular embodiments of the present disclosed subject matter. Reference will now be made to the drawings in which the various elements of the illustrated configurations will be given numerical designations and in which the disclosed subject matter will be discussed so as to enable one skilled in the art to make and use the subject matter. It is to be understood that the following description is only exemplary of the principles of the present disclosed subject matter, and should not be viewed as narrowing the scope of the claims which follow, which claims define the full scope of the disclosed subject matter.

It will be appreciated that various aspects discussed in one drawing may be present and/or used in conjunction with the embodiment shown in another drawing, and each element shown in multiple drawings may be discussed only once. For example, in some cases, detailed description of well-known items or repeated description of substantially the same configurations may be omitted. The reason is to facilitate the understanding of those skilled in the art by avoiding the following description from being unnecessarily redundant. The accompanying drawings and the following description are provided in order for those skilled in the art to fully understand the present disclosure, and these are not intended to limit the gist disclosed in the scope of claims.

It should be noted that the description merely illustrates the principles of the present subject matter. It will thus be appreciated that those skilled in the art will be able to devise various arrangements that, although not explicitly described herein, embody the principles of the present subject matter and are included within its spirit and scope. Furthermore, all examples recited herein are principally intended expressly to be only for pedagogical purposes to aid the reader in understanding the principles of the disclosed subject matter and the concepts contributed by the inventor(s) to furthering the art, and are to be construed as being without limitation to such specifically recited examples and conditions. Moreover, all statements herein reciting principles, aspects, and embodiments of the disclosed subject matter, as well as specific examples thereof, are intended to encompass equivalents thereof.

Reference in the specification to “one configuration” “one embodiment,” “a configuration” or “an embodiment” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” in various places may not necessarily limit the inclusion of a particular element of the disclosed subject matter to a single configuration, rather the element may be included in other or all configurations discussed herein.

Furthermore, the described features, structures, or characteristics of configurations of the disclosed subject matter may be combined in any suitable manner in one or more configurations. In the following description, numerous specific details are provided, such as examples of products or manufacturing techniques that may be used, to provide a thorough understanding of configurations of the disclosed subject matter. One skilled in the relevant art will recognize, however, that configurations of the disclosed subject matter may be practiced without one or more of the specific details, or with other methods, components, materials, and so forth. In other instances, well-known structures, materials, or operations are not shown or described in detail to avoid obscuring aspects of the disclosed subject matter.

Before the present disclosed subject matter is disclosed and described in detail, it should be understood that the present disclosure is not limited to any particular structures, process steps, or materials discussed or disclosed herein, but is extended to include equivalents thereof as would be recognized by those of ordinary skill in the relevant art. More specifically, the disclosed subject matter is defined by the terms set forth in the claims. It should also be understood that terminology contained herein is used for the purpose of describing particular aspects of the disclosed subject matter only and is not intended to limit the disclosed subject matter to the aspects or configurations shown unless expressly indicated as such. Likewise, the discussion of any particular aspect of the disclosed subject matter is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a shade sample/swatch” may include one or more of such shade samples/swatches, and reference to “the shade sample/swatch” may include reference to one or more of such shade samples/swatches.

As used herein, the term “substantially” refers to the complete or nearly complete extent or degree of an action, characteristic, property, state, structure, item, or result to function as indicated. For example, a surface that is “substantially” planar would mean that the surface is either completely planar or nearly completely planar. Similarly, a material which is “substantially transparent” would mean the material is either completely transparent or nearly completely transparent, i.e., translucent. As used herein, “transparent” and “translucent” are used interchangeably to mean a surface or material that allows light to pass through. The exact allowable degree of deviation from absolute completeness may in some cases depend on the specific context. The use of “substantially” is equally applicable when used in a negative connotation to refer to the complete or near complete lack of an action, characteristic, property, state, structure, item, or result. For example, a shade guide which is “substantially free of” a certain material would either completely lack said material or so nearly completely lack said material that the effect would be effectively the same as if it lacked said material.

As used herein the term “generally” refers to something that is more of the designated adjective than not, or the converse if used in the negative.

As used herein, the term “about” is used to provide flexibility to a numerical range endpoint by providing that a given value may be “a little above” or “a little below” the endpoint while still accomplishing the function associated with the range. As used herein, “shade swatch” means any type of sample suitable for comparing a shade of the swatch to a shade of a tooth.

As used herein, a plurality of items, structural elements, compositional elements, and/or materials may be presented in a common list for convenience. However, these lists should be construed as though each member of the list is individually identified as a separate and unique member.

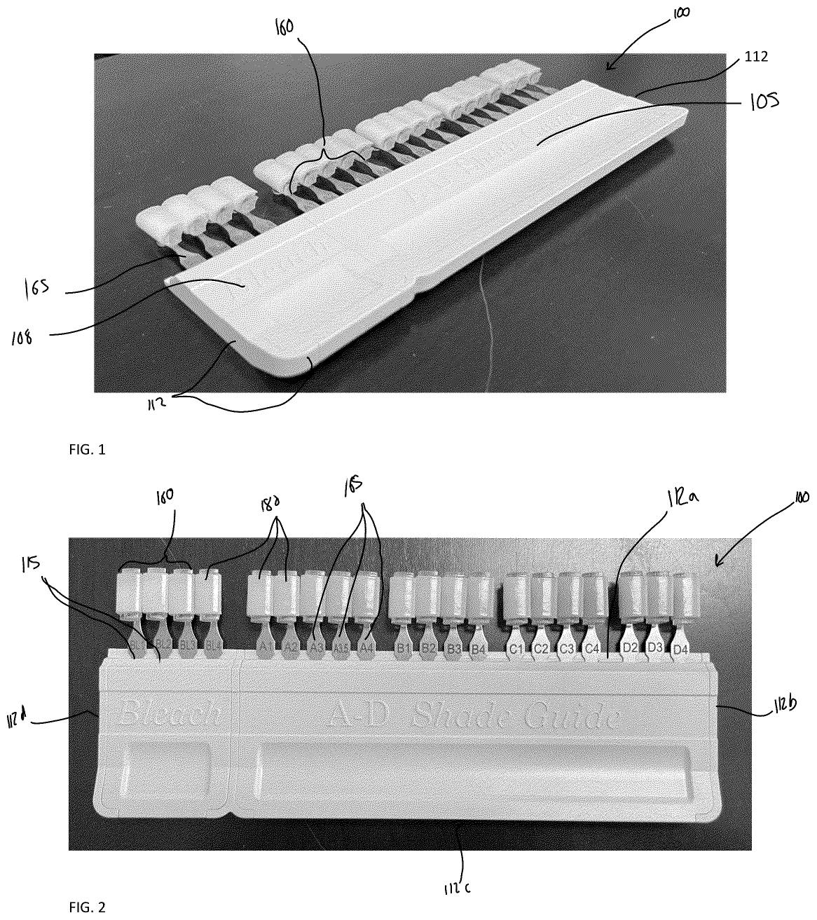

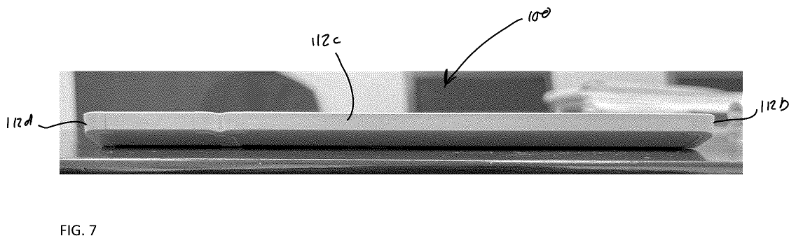

FIGS. 1-7 illustrate an embodiment of a shade guide 100, which may be a shade guide 100 for comparing shades of various materials (and compositions of materials) for dental prosthesis to a shade of a tooth. Shade guide 100 may comprise a housing 105 and a plurality of shade swatches 160, which may be at least partially housed within housing 105. The housing 105 may comprise any number of shapes and sizes that are suitable for housing and organizing shade swatches. FIG. 1 illustrates, by way of example, that housing 105 may comprise a substantially rectangular body or slab of material. Housing 105 may comprise a front surface 108, a back surface 110 (see FIG. 4), and lateral walls 112, which extend between the front surface 108 and the back surface 110. Front surface 108 and back surface 110 may be substantially rectangular and substantially planar. The housing 105 may be made out of any number of suitable materials, including but not limited to plastic or like materials. Housing 105 may also be alternate shapes and sizes, such as a circular shape, square, etc.

Referring to FIG. 2, lateral walls 112 may comprise a top lateral wall 112a, a first side lateral wall 112b, a bottom lateral wall 112c, and a second side lateral wall 112d. Housing 105 may comprise a plurality of voids 115 along the top lateral wall 112a (alternatively, voids may be along the bottom lateral wall 112c, first side lateral wall 112b, and/or second side lateral wall 112d). The plurality of voids 115 may extend inwardly into the housing 105 from the first lateral wall 112a toward the bottom lateral wall 112c.

The plurality of voids 115 may be arranged in a substantially parallel manner relative to one another. Each void of the plurality of voids 115 may comprise any number of shapes and sizes that are suitable for housing a portion of a shade swatch of the plurality of shade swatches 160. By way of example, and not limitation, each void of the plurality of voids 115 may comprise a thin rectangular opening that extends into the housing 105 from the top lateral wall 112a toward the bottom lateral wall 112c. (See, e.g., FIG. 6). In this example, the shade swatches 160 may each include a post 165 that has a thin rectangular shape, so the post 165 is selectively insertable and removable from the plurality of voids 115.

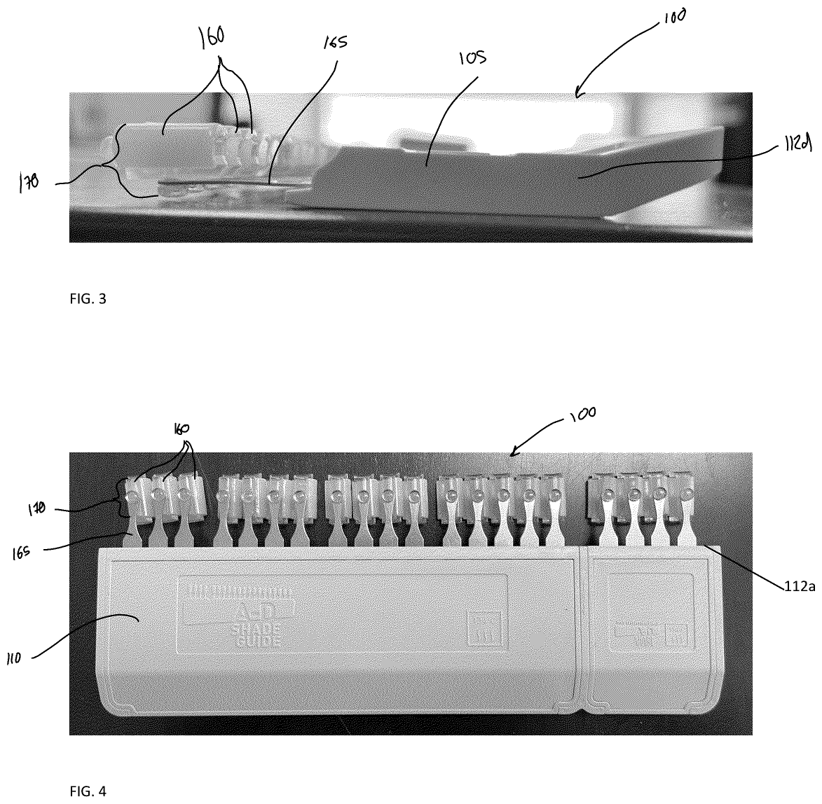

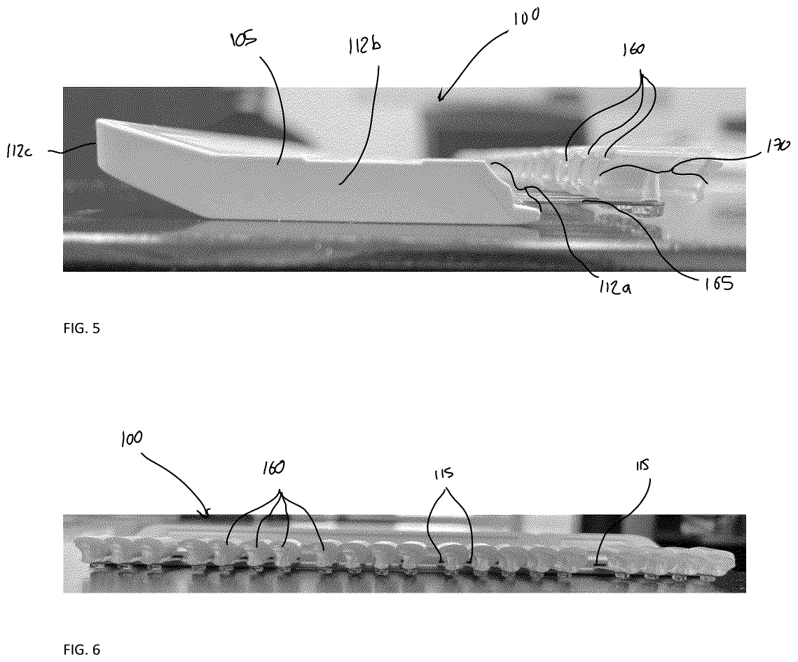

Referring to FIGS. 3 and 5, each shade swatch of the plurality of shade swatches 160 may comprise a post 165 with a shade tip 170 attached to an end of the post 165. The post 165 may be a shank, a shaft, or a stem that extends away from the shade tip 170. The plurality of voids 115 may each have a volume that corresponds substantially with a volume of a portion of the posts 165 opposite the shade tips 170 of the plurality of shade swatches 160. As such, a user of the shade guide 100 may insert posts 165 of the plurality of shade swatches 160 into the plurality of voids 115 of the housing 105 in order to store and/or organize the plurality of shade swatches 160.

The user may desire to organize the plurality of shade swatches 160 along a length of the top lateral wall 112a according to any number of criteria. By way of example, and not limitation, a user may desire to organize the plurality of shade swatches 160 by color, lightness, chroma, or hue of the shade tips 170. Alternatively, a user may desire to organize the plurality of shade swatches 160 by the type of material(s) that the shade tips 170 are made out of, which may determine how much it would cost to make dental prosthesis out of such materials.

FIG. 4 illustrates that when the posts 165 of the plurality of shade swatches 160 are housed within the plurality of voids 115 of the housing, the shade tips 170 of the shade swatches 160 may be positioned next to one another above the top lateral wall 112a of the housing 105.

FIG. 6 illustrates that plurality of voids 115 may be separated into distinct groups of voids that are distanced farther apart from other groups of voids. These groups of voids may enable a user to organize the plurality of shade swatches 160 into distinct groups as desired. For example, a user may desire to place certain shade swatches that comprise similar hues or similar materials close together in separated groups.

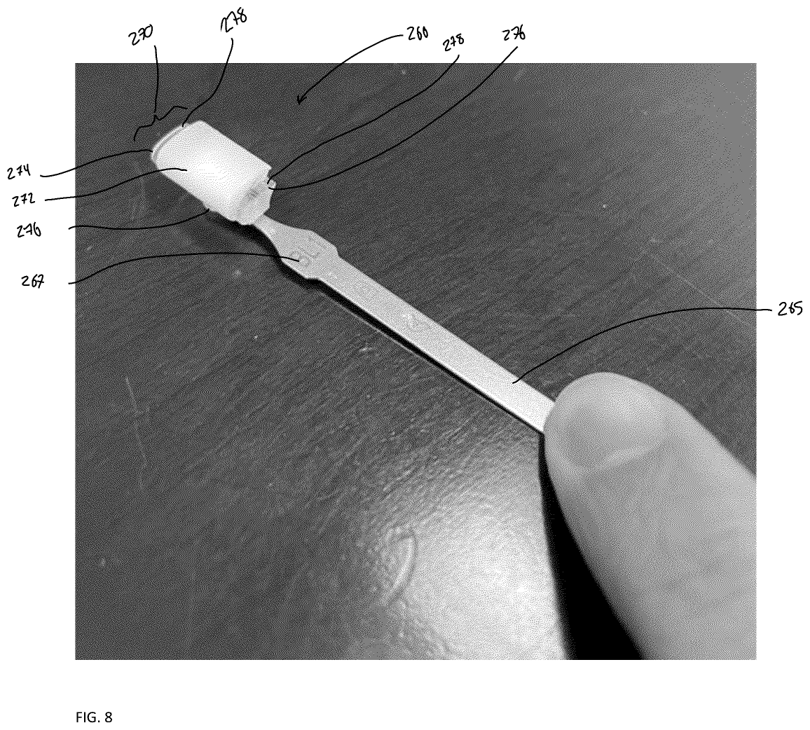

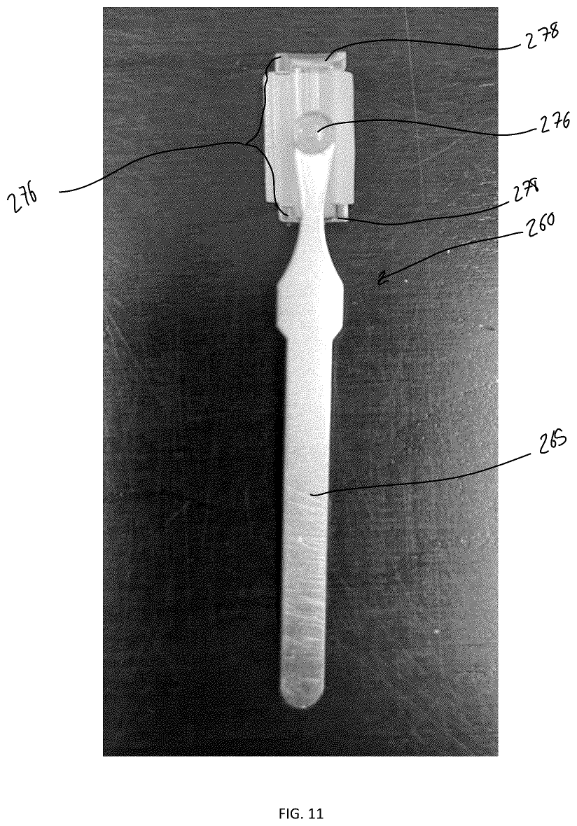

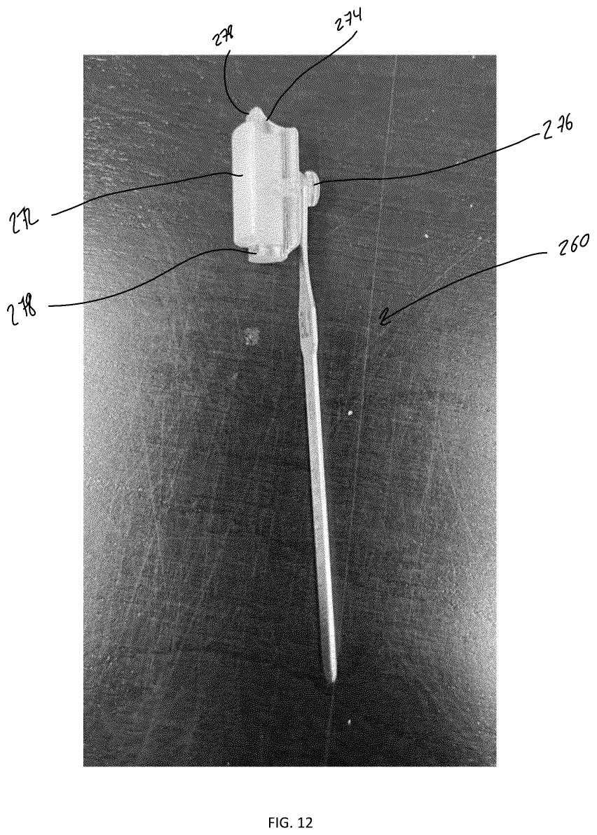

FIGS. 8-14 illustrate an embodiment of a shade swatch 260, which may be substantially similar to the shade swatches of the plurality of shade swatches 160. Shade swatch 260 may comprise a post 265 with a shade tip 270 attached to an end of the post 265. Post 265 may comprise an indicator 267, which may be positioned on post 265 near the shade tip 270. The indicator 267 may comprise a combination of letters and/or numbers that are used identify particular qualities of the shade tip 270 located on the shade swatch 260, such as a color, hue, lightness, chroma, or composition of a particular shade tip 270.

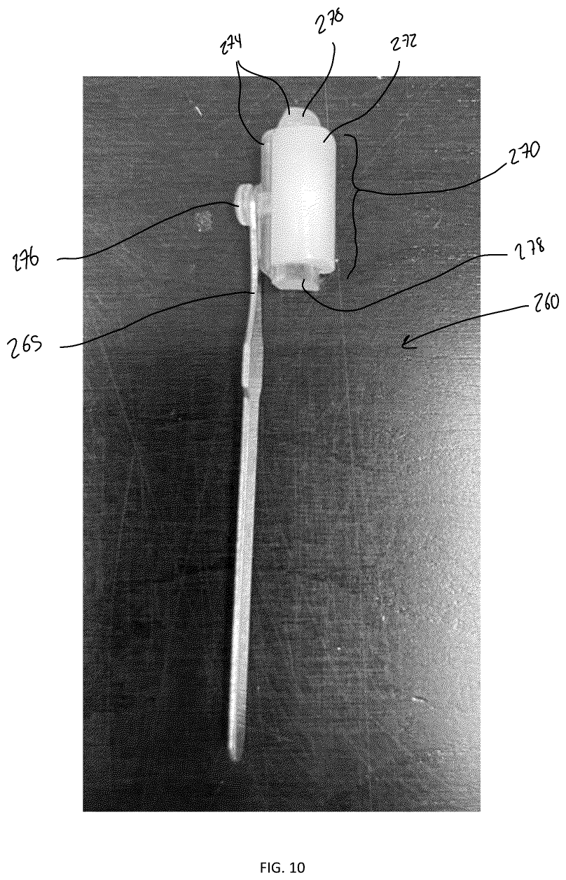

Shade tip 270 may comprise a prosthesis or shade sample 272 formed of an opaque or semi-opaque material, the shade sample 272 surrounding a central transparent adapter 274, and a fastener 276 attaching the shade tip to a post 265. The shade sample 272 may be secured to the central core adapter 274, and the fastener 276 may secure the adapter 274 and the shade sample 272 to an end of the post 265. Shade tip 270 may be rotatably secured to an end of the post 265 such that the shade tip may be rotated into different positions or orientations by the user in order to compare different portions of the shade sample 272 to a patient's tooth/teeth. By way of example and not limitation, FIG. 10 illustrates that fastener 276 may comprise a pin that may pass through a hole in post 265 and extend into adapter 274 and be fixed to adapter 274, thereby rotatably fixing shade tip 270 to post 265. Shade tip may rotate or pivot about the fastener 276 for convenient placing when matching the shade tip to a patient's tooth.

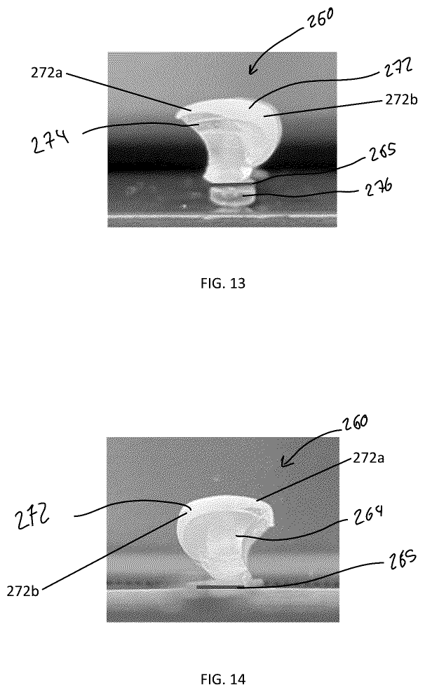

FIGS. 8-14 also illustrate that shade sample 272 may comprise an opaque or generally opaque layer of dental prosthesis material that surrounds the transparent adapter 276. Shade sample is shown as having a shape that tapers from a relatively thin layer 272a of dental prosthesis material at one end of the sample to a thicker layer 272b of dental prosthesis material on another end of the shade sample 272. See FIGS. 13 and 14 in particular. By way of example and not limitation, the shade sample 272 may comprise the shape of a rounded check mark or an irregular tear drop like shape (see FIGS. 13 and 14) that may be extended into a prism (see FIG. 8). The varying thickness of the shade sample 272 may mimic the natural variations in enamel and assist in accurate shade matching. In other configurations, the shade sample 272 has a uniform thickness.

There are many different materials that may be used to prepare dental prosthesis, including by way of example and not limitation: composites, resins, zirconium dioxide (ZRo2), PMMA, plastics, pre-cure and pre-processed plastics for use in milling and “CAM” software processes, glass ceramics, and various other materials which may be commonly used for crafts and jewelry, such as wood, metal, other such materials, and any number of compositions of the aforesaid materials. Examples of compositions of materials may include resin mixed with ceramics to provide long term temporary prosthesis or crowns. Examples of glass ceramics may include glass ionomers, feldspathic glass, lithium disilicate, lithium silicate, and compositions of zirconium dioxide (ZRo2) mixed with a silicate.

Each material or composition that is used to make dental prosthesis exhibits different color qualities—different hues (colors), different chromas (degrees of saturation), and different color values (relative amounts of white/grey). The width and shape of the material(s) used to create dental prosthesis effect what color qualities a dental implant exhibits and the overall appearance thereof. Accordingly, the tapered thickness of the shade sample 272 may allow a user to compare visual aspects of the shade sample 272 and its associated material(s) at different thicknesses in order to determine how a veneer, or dental implant that is made out of certain material(s) will look and how thick the dental implant must be to obtain the desired color qualities.

Adapter 274 of the shade tip 270 may comprise any number of suitable materials, such as plastic and other like materials. Adapter 274 may comprise a material that is clear, transparent, semi-transparent, translucent, semi-translucent, or may have appropriate characteristics that allow light to pass through the adapter 274. Such qualities may enable a user of the shade swatch 260 to position the shade sample 272 of the shade tip 270 near a patient's teeth, or even inside the patient's mouth, for comparison with the patient's teeth without compromising the accuracy of the comparison by blocking the light (because light may pass through the transparent adapter 276 in a natural manner as if the adapter 274 were not there). If the adapter 274 were opaque or semi-opaque, it may block light and affect how the color of the shade sample 272 appears in relation to the dental patient's teeth. As such, transparent/translucent qualities of the adapter 276 may facilitate accurate comparison of the sample 272 to a patient's teeth.

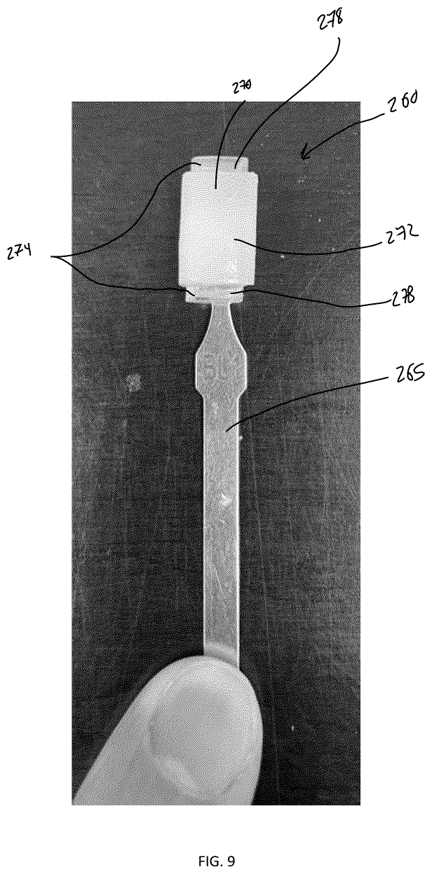

As illustrated in FIGS. 9-12, adapter 274 may also comprise one or more positioning notches 278. Positioning notches 278 may comprise lips that extend up above or below the shade sample 272 on the shade tip 270. Positioning notches 278 may facilitate positioning of the shade sample 272 beside, beneath, or around a patient's tooth/teeth. By way of example and not limitation, a user may hold shade swatch 260 by the post 265 to position the shade sample 272 of the shade tip 270 near a patient's tooth/teeth for comparison. In order to hold the shade tip 270 in a desired position near the patient's tooth/teeth, the user may place the positioning notch 278 against a portion of the patient's tooth/teeth and hold it there, thereby steadying the shade tip 270 against the patient's tooth/teeth. For example, the user may place the shade tip 270 beneath or above a patient's front teeth—the sample 272 facing out of the patient's mouth—and place the positioning notch 278 against a back side of the patient's teeth such that the sample is situated directly beside or beneath the user's teeth. In this way, the positioning notch 278 may enable to the user to hold the shade swatch 260 steadily in a desired position or orientation while comparing the shade sample 272 to the patient's teeth.

Additionally, because of the transparent/translucent qualities of the adapter 274, the positioning notches 278 of the adapter 274 may permit light to pass through the patient's teeth and the positioning notches 278 behind the patient's teeth in a natural manner as if the positioning notches were not there, which may help to facilitate an accurate comparison between the sample 272 and the patient's tooth/teeth in as natural of lighting as possible.

A plurality of shade swatches that are substantially similar to shade swatch 260 may be used in connection with a shade guide such as shade guide 100.

Referring back to FIGS. 1-7, a user may desire to remove various different shade swatches of the plurality of shade swatches 160 from the plurality of voids 115 of the housing 105 in order to compare the different shade swatches individually against a patient's teeth until the user has determined which shade tip most closely approximates the color qualities of a patient's teeth.

What is claimed:

1. A shade swatch, comprising:
a shade tip attached to a post, the shade tip comprising:
an adapter in connection with the post, the adapter comprised of a transparent material; and
a shade sample in connection with the adapter, the shade sample formed of a material that is at least partially opaque and the shade sample having a curved shape that is tapered from a first portion of the material to a second portion of the material, the first portion of the material having a greater thickness than the second portion of the material;
and wherein the adapter comprises a positioning notch that extends outwardly from the shade sample, the positioning notch for positioning the shade sample proximal to a user's tooth to match a shade of the shade sample to the user's tooth.

2. A dental matching shade swatch comprising:
a shade tip in connection with a post, the shade tip comprising a transparent adapter central core, and an outer shade sample material surrounding the transparent adapter central core; and
a positioning notch extending beyond the transparent adapter central core, the positioning notch formed of a transparent material and the positioning notch facilitating positioning the outer shade sample material proximal to a patient's tooth.

3. The dental matching shade swatch of claim 2, further comprising a fastener for rotatably fastening the transparent adapter central core to the post.

4. The dental matching shade swatch of claim 2, further comprising a transparent fastener for rotatably connecting the shade tip to a post.

5. The dental matching shade swatch of claim 4, wherein the post insertable into a void of a housing.

6. The dental matching shade swatch of claim 2, wherein the outer shade sample material has a thickness around the transparent adapter central core, and wherein the thickness varies from a first side of the transparent adapter central core to a second side of the transparent adapter central core.

7. The dental matching shade swatch of claim 2, wherein the outer shade sample material has a thickness around the transparent adapter central core, and wherein the thickness is uniform.

8. A dental matching shade swatch comprising:
a shade tip, the shade tip comprising a transparent adapter central core, and an outer shade sample material surrounding the transparent adapter central core;
a transparent fastener for rotatably connecting the shade tip to a post, the post insertable into a void of a housing; and
a positioning notch extending beyond the transparent adapter central core, the positioning notch formed of a transparent material and the positioning notch facilitating positioning the outer shade sample material proximal to a patient's tooth.
